(19) United States
(12) Patent Application Publication
(10) Pub. No.: US 2026/0042337 A1
(43) Pub. Date: Feb. 12, 2026

(54) VEHICLE AIR EXTRACTOR HAVING A DEFLECTOR COVER

(71) Applicant: Ford Global Technologies, LLC, Dearborn, MI (US)

(72) Inventors: Timothy John Wittrock, Novi, MI (US); Adolfo Tapia Borgo, Hermosillo (MX); Jose Ernesto Simón Gonzalez, Culiacan (MX)

(73) Assignee: Ford Global Technologies, LLC, Dearborn, MI (US)

(21) Appl. No.: 18/797,814

(22) Filed: Aug. 8, 2024

(51) Int. Cl. B60H 1/24

(52) U.S. Cl. CPC B60H 1/248

(57) ABSTRACT

A vehicle air extractor has a housing configured to be located on a motor vehicle in airflow communication with a cabin interior of the vehicle and defining an exhaust outlet. One or more flaps are disposed within the exhaust outlet and moveable between an open position allowing air to flow through the exhaust outlet. A closed position closes off the exhaust outlet and prevents air from flowing through the exhaust outlet. A deflector cover is positioned to at least partially block air from flowing freely through the exhaust outlet to reduce flap noise that may be generated by the one or more flaps.

### FIELD OF THE DISCLOSURE

The present disclosure generally relates to vehicle vent assemblies, and more particularly relates to a vehicle air extractor that allows for air to be exhausted from the cabin interior and reduces flap noise.

### BACKGROUND OF THE DISCLOSURE

Motor vehicles are commonly equipped with one or more air extractors which operate as exhaust vents for venting pressurized air from the cabin interior of the motor vehicle. The air extractor typically includes a vent such as a one-way vent having one or more flaps for exhausting the air to the exterior environment, such as when a door on the vehicle is closed, to thereby reduce the cabin air pressure. The flaps may be susceptible to creating flap noise, particularly when the vehicle ventilation system is in recirculation mode. It would be desirable to provide for an air extractor that reduces flap noise caused by the one or more flaps.

### SUMMARY OF THE DISCLOSURE

According to a first aspect of the present disclosure, a vehicle air extractor has a housing configured to be located on a motor vehicle in airflow communication with a cabin interior of the vehicle and defining an exhaust outlet. One or more flaps are disposed within the exhaust outlet and moveable between an open position allowing air to flow through the exhaust outlet. A closed position closes off the exhaust outlet and prevents air from flowing through the exhaust outlet. A deflector cover is positioned to at least partially block air from flowing freely through the exhaust outlet to reduce flap noise that may be generated by the one or more flaps.

Embodiments of the first aspect of the present disclosure can include any one or a combination of the following features:
the deflector cover is coupled to the housing;
the deflector cover is located on an inboard side of the housing;
the air deflector cover includes a planer portion;
the air deflector cover comprises a curved portion;
the curved portion curves inward towards the housing;
the air deflector cover is coupled to an outboard portion of the housing;
the air deflector cover forms a cup-shaped portion, wherein at least a portion of the one or more flaps may enter a space in the cup-shaped portion when in the open position;
the one or more flaps comprises a plurality of flaps; and
the one or more flaps are configured to hang from one or more pivot supports coupled to the housing.

According to a second aspect of the present disclosure, a motor vehicle has a body defining a cabin interior, an opening providing fluid communication between the cabin interior and an outside environment, and an air extractor disposed in the opening. The air extractor has a housing in airflow communication with the cabin interior and defining an airflow exhaust outlet. One or more flaps are disposed within the airflow exhaust outlet and moveable between an open position allowing air to flow through the airflow exhaust outlet. A closed position closes off the airflow exhaust outlet and prevents air from flowing through the airflow exhaust outlet. A deflector cover is positioned to at least partially block air from flowing freely through the airflow exhaust outlet to reduce flapping sounds that may be generated by the one or more flaps.

Embodiments of the second aspect of the present disclosure can include any one or a combination of the following features:
the deflector cover is coupled to the housing;
the deflector cover is located on an inboard side of the housing;
the air deflector cover includes a planer portion;
the air deflector cover comprises a curved portion;
the curved portion curves inward towards the housing;
the air deflector cover is coupled to an outboard portion of the housing;
the air deflector cover forms a cup-shaped portion, wherein the one or more flaps may enter a space in the cup-shaped portion when in the open position;
the one or more flaps comprises a plurality of flaps; and
the one or more flaps are configured to hang from one or more pivot supports coupled to the housing.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top view of a motor vehicle equipped with air extractors, according to one example;

FIG. 2 is a rear perspective view of the motor vehicle shown in FIG. 1 further illustrating the air extractors near the rearend of the vehicle;

FIG. 3 is a rear perspective view of the outboard side of an air extractor, according to one example;

FIG. 3A is a front view of the inboard side of the air extractor shown in FIG. 3 without a deflector cover;

FIG. 4 is a front perspective view of the inboard side of the air extractor having a deflector cover having a planer portion coupled to the inboard side of the air extractor, according to a first embodiment;

FIG. 4A is a side view of the air extractor shown in FIG. 4;

FIG. 5 is a front perspective view of the inboard side of the air extractor having a deflector cover that is curved, according to a second embodiment;

FIG. 5A is a side view of the air extractor shown in FIG. 5;

FIG. 6 is a rear perspective view of the outboard side of the air extractor having a cup-shaped deflector cover on the outboard side of the vent, according to a third embodiment; and

FIG. 6A is a side view of the air extractor shown in FIG. 6.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

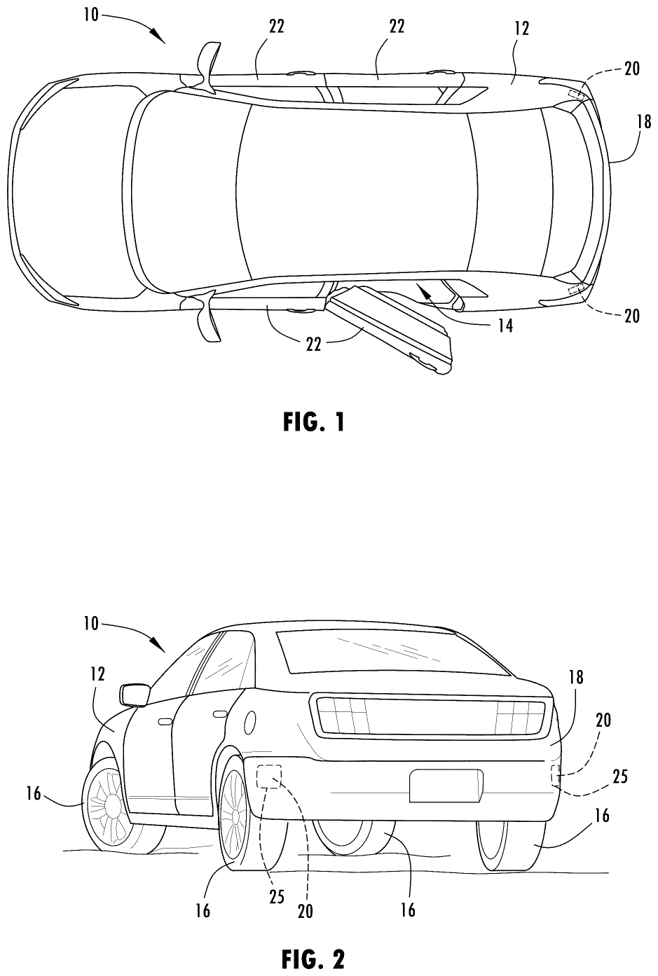

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle air extractor and vehicle having an air extractor. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

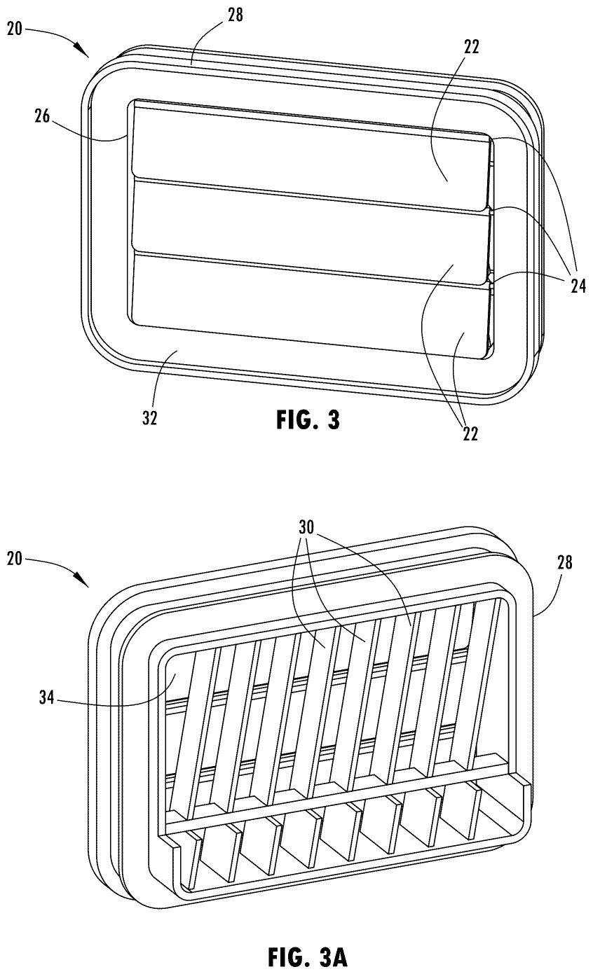

Referring to FIGS. 1 and 2, a wheeled automotive or motor vehicle 10 is generally illustrated having a vehicle body 12 defining a cabin interior 14. The cabin interior 14 generally includes passenger seating and other accommodations for transporting one or more occupants. The motor vehicle 10 shown and described herein is a wheeled motor vehicle having a plurality of wheel and tire assemblies 16, particularly four wheel and tire assemblies 16 shown in one example mounted onto the axles of the motor vehicle 10. The motor vehicle 10 has front and rear side passenger doors 22 on both lateral sides of the body 12 that allows access to the passenger seating and a rear end 18 such as a trunk or liftgate at the rear end of the motor vehicle 10 that allows access to the rear end of the cabin interior 14. The motor vehicle 10 may be configured as a sedan, truck, SUV, van, bus or other vehicle having a closeable cabin interior.

The motor vehicle 10 includes one or more air extractors 20 operatively coupled to the cabin interior 14 for exhausting pressurized air from within the cabin interior 14 to the outside environment. Pressurized air may be created in the cabin interior 14 when a door is moved from the open position to the closed position to compress the air in the cabin interior 14. Pressurized air may also be created in the cabin interior 14 when air is introduced via a fan or other blower into the cabin interior 14 by the ventilation system such as a heating, ventilation and air conditioning (HVAC) system. As such, the air pressure within the cabin interior 14 may exceed the atmospheric air pressure in the environment outside of the motor vehicle 10.

Each air extractor 20 includes one or more flaps 22, and preferably has a plurality of flaps 22. Each of the flaps 22 may be coupled to pivot supports 24, such as elongate pins that may pivot within receptacles on the top side thereof which extends generally along a horizontal pivot axis. As such, the flaps 22 hang from each pivot support 24 due to gravity and may rotate about the horizontal pivot axis between an open exhaust vent position and a closed exhaust vent position. According to one embodiment, the plurality of flaps 22 may be one-way airflow valves that open outward towards the outboard side due to a pressure differential when the pressure inside the cabin interior 14 is greater than the atmospheric pressure in the surrounding exterior environment. The air extractors 20 allow the higher pressure airflow from the cabin interior 14 of the motor vehicle 10 to be exhausted from the cabin interior 14 into the outside environment. The air extractors 20 may abut and contact a back support structure on the rear peripheral edge in the closed position which prevents airflow in the opposite direction.

As seen in the example illustrated in FIGS. 1 and 2, the one or more air extractors 20 include two air extractors, one on each side at the rear end 18 of the motor vehicle 10. Each air extractor 20 may be located within an opening 25 in the body 12 of the motor vehicle 10 and may contact the back support structure in the closed position. The opening 25 is in fluid communication with the cabin interior 14. It should be appreciated that any of a number of one or more air extractors 20 may be located in any location in fluid communication with the cabin interior 14 to allow air, particularly pressurized air, to be exhausted and vented from within the cabin interior 14 in the motor vehicle 10 to the outside environment.

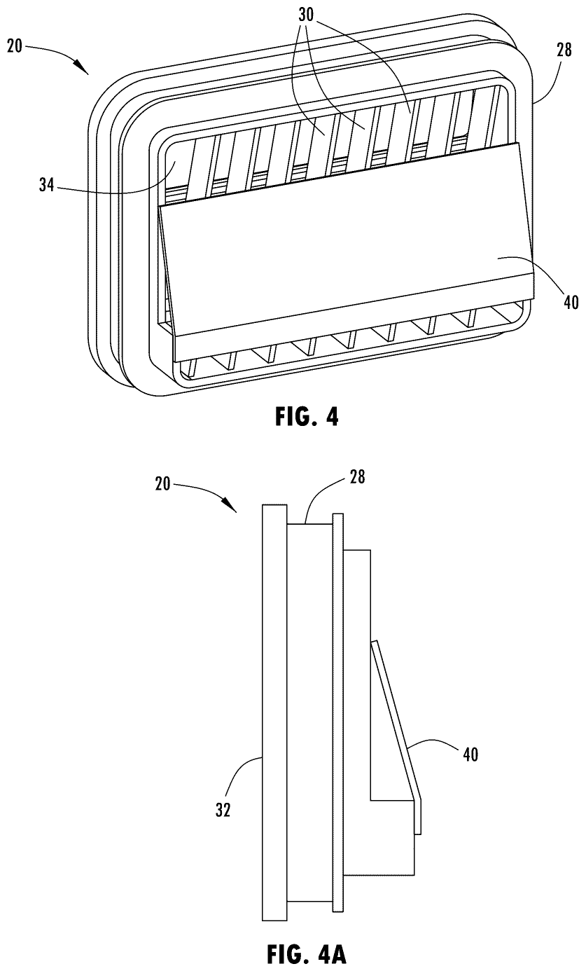

Referring to FIGS. 3 and 3A, the air extractor 20 is shown having a housing 28 generally having a shape and size to be inserted and mounted within the opening 25 in the body 12 of the motor vehicle 10 in fluid communication with the cabin interior 14 on the inboard side and the outside environment on the outboard side. In the example shown, the housing 28 has a generally rectangular shape with rounded corners and a perimeter that generally confirms to the shape and size of the opening 25. The housing 28 defines an airflow exhaust outlet 26 in fluid communication with the cabin interior 14 and the outside environment. One or more flaps 22 are coupled to the housing 28 within the airflow exhaust outlet 26. In the example shown, three flaps 22 are stacked one above the other to substantially fill and close off the airflow exhaust outlet 26 when the flaps 22 are in the closed position as seen from the outboard side in FIG. 3. Each of the flaps 22 is connected to the housing 28 via a pivot support 24, such as may be provided by pivot pins rotatable about a pivot axle provided on opposite lateral sides. As such, each flap 22 hangs from the pivot support 24 to a downward closed position due to gravity. When air pressure within the cabin interior 14 exceeds the air pressure in the outside environment, each 22 may be forced by the pressurized air to swing outward towards the outboard side to an open position to allow airflow to flow and exhaust from inside the cabin interior 14 to the outside environment.

The inboard side of the air extractor 20 is shown in FIG. 3A with the air deflector cover 40 removed. The inboard side is generally the side that faces towards the interior of the cabin interior 14 of the motor vehicle 10. A plurality of vertical slats 30 are shown arranged in the interior side of the air extractor 20 connected in parallel to the housing 28 which assist with directing airflow in an air stream through the exhaust outlet 26 in the air extractor 20.

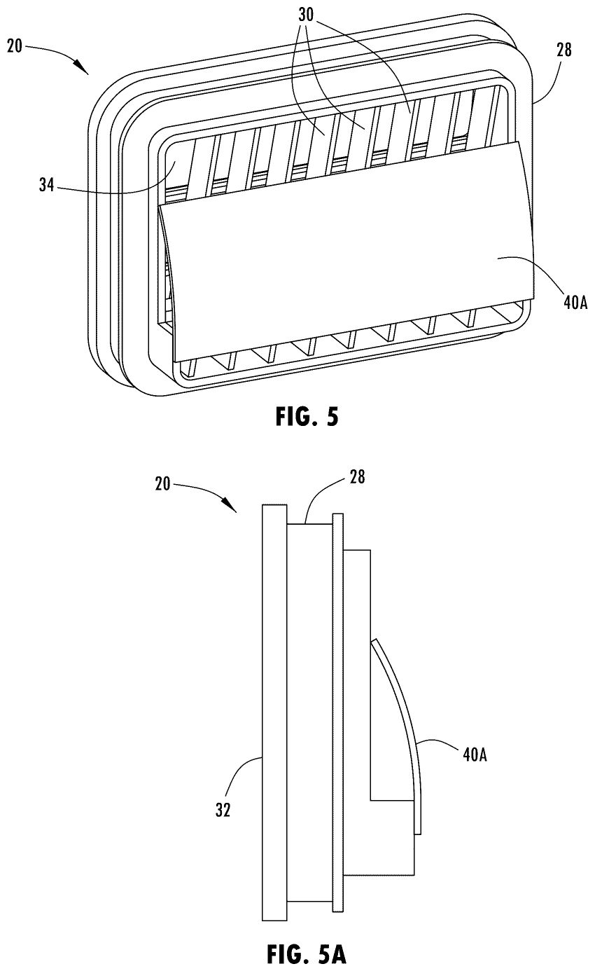

Referring to FIGS. 4 and 4A, the air extractor 20 is shown having the deflector cover 40 connected to the inboard side of the housing 28, according to a first embodiment. In this embodiment, the defector cover 40 has a planer portion that extends along a portion of the inboard side of the air extractor 20. In one example, the deflector cover 40 extends over at least fifty percent (50%) of the inboard side of the air extractor. The deflector cover 40 is positioned to at least partially block air from flowing freely in an airstream through the entire airflow exhaust outlet 26 with an increased back pressure in order to reduce flap noise generated by the one or more flaps 22. It should be appreciated that flap noise may otherwise be generated, particularly when the air ventilation system of the motor vehicle 10 is in a recirculation mode which may result in a substantially equal air pressure within the cabin interior 14 as compared to the outside environment such that the flaps 22 may move by swinging and contact a structure such as the back support structure. The deflector cover 40 helps to reduce the pivoting movement of the one or more flaps 22 and hence the flap noise that may otherwise be generated. In the example shown, the deflector cover 40 is connected to a lower portion of the housing 28 on the inboard side of the air extractor 20. However, it should be appreciated that the deflector cover 40 may be connected to other portions of the housing 28 and may extend over a greater or lesser area of the airflow exhaust outlet 26.

Referring to FIGS. 5 and 5A, the air extractor 20 is shown having a deflector cover 40A, according to a second embodiment. In this embodiment, the deflector cover 40A has a curved portion that is curved inward on the inboard side of the air extractor 20 towards the vertical slats 30 over at least a portion of the airflow exhaust outlet 26 to at least partially block air from flowing freely through the airflow exhaust outlet 26. The air deflector cover 40A may be connected to a lower portion of the housing 28 and may curve along a curvature to a location in close proximity to or in contact with the vertical slats 30. The air defector cover 40A may extend over at least fifty percent (50%) of the inboard side of the air extractor 20, according to one example. The air deflector cover 40A may extend over a greater or lesser area to at least partially block the airflow flowing freely in an air stream through the airflow exhaust outlet 26.

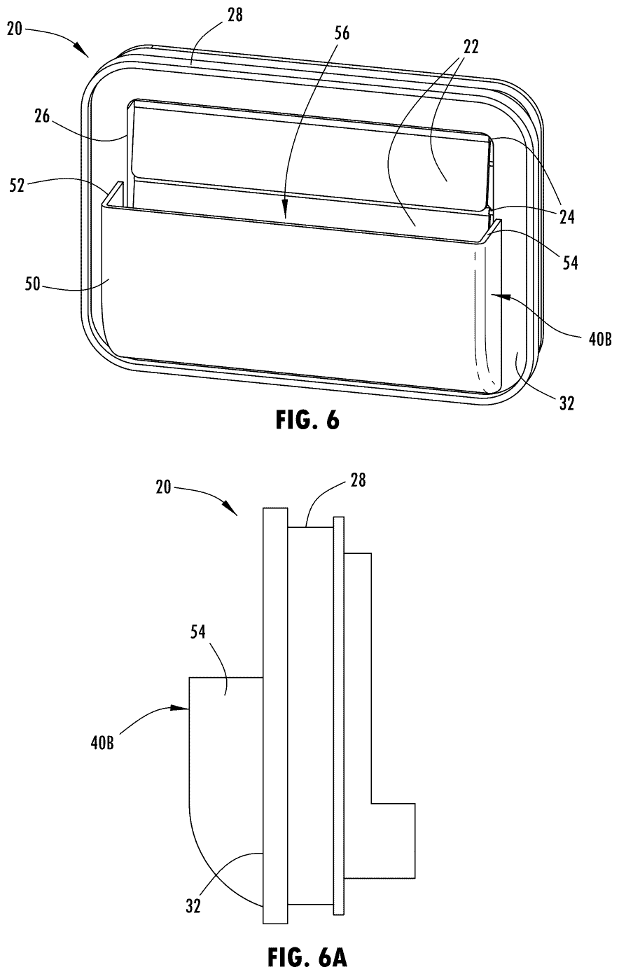

Referring to FIGS. 6 and 6A, the air extractor 20 is shown having a deflector cover 40B connected to an inboard side of the housing 28, according to a third embodiment. The deflector cover 40B has a generally cup-shaped member defining an outward extending wall 50 connected to sidewalls 52 and 54 on opposite lateral sides. The deflector cover 40B has a somewhat rectangular cup-shaped pocket that defines a space 56 bordered by walls 50, 52, 54 and the outboard side of at least a portion of the “flaps 22,” particularly the lower portion of the flaps 22. As such, the cup-shaped air deflector cover 40B at least partially blocks air from flowing freely in an air stream through the airflow exhaust outlet 26 to thereby reduce flap noise.

Accordingly, a vehicle air extractor 20 is provided for a motor vehicle 10 to extract air such as pressurized air from the cabin interior 14 in a manner that reduces or minimizes flap noise. The air extractor 20 includes a deflector cover 40, 40A or 40B that at least partially blocks air from flowing freely in an air stream through the airflow opening to reduce flap noise that may otherwise be generated by the one or more flaps 22.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle air extractor comprising:
a housing configured to be located on a motor vehicle in airflow communication with a cabin interior of the vehicle and defining an exhaust outlet;
one or more flaps disposed within the exhaust outlet and moveable between an open position allowing air to flow through the exhaust outlet and a closed position closing off the exhaust outlet and preventing air from flowing through the exhaust outlet; and
a deflector cover positioned to at least partially block air from flowing freely through the exhaust outlet to reduce flap noise that may be generated by the one or more flaps.

2. The vehicle air extractor of claim 1, wherein the deflector cover is coupled to the housing.

3. The vehicle air extractor of claim 2, wherein the deflector cover is located on an inboard side of the housing.

4. The vehicle air extractor of claim 3, wherein the air deflector cover includes a planer portion.

5. The vehicle air extractor of claim 3, wherein the air deflector cover comprises a curved portion.

6. The vehicle air extractor of claim 5, wherein the curved portion curves inward towards the housing.

7. The vehicle air extractor of claim 2, wherein the air deflector cover is coupled to an outboard portion of the housing.

8. The vehicle air extractor of claim 7, wherein the air deflector cover forms a cup-shaped portion, wherein at least a portion of the one or more flaps may enter a space in the cup-shaped portion when in the open position.

9. The vehicle air extractor of claim 1, wherein the one or more flaps comprises a plurality of flaps.

10. The vehicle air extractor of claim 1, wherein the one or more flaps are configured to hang from one or more pivot supports coupled to the housing.

11. A motor vehicle comprising:
a body defining a cabin interior;
an opening providing fluid communication between the cabin interior and an outside environment; and
an air extractor disposed in the opening, the air extractor comprising:
a housing in airflow communication with the cabin interior and defining an airflow exhaust outlet;
one or more flaps disposed within the airflow exhaust outlet and moveable between an open position allowing air to flow through the airflow exhaust outlet and a closed position closing off the airflow exhaust outlet and preventing air from flowing through the airflow exhaust outlet; and
a deflector cover positioned to at least partially block air from flowing freely through the airflow exhaust outlet to reduce flapping sounds that may be generated by the one or more flaps.

12. The motor vehicle of claim 11, wherein the deflector cover is coupled to the housing.

13. The motor vehicle of claim 12, wherein the deflector cover is located on an inboard side of the housing.

14. The motor vehicle of claim 13, wherein the air deflector cover includes a planer portion.

15. The motor vehicle of claim 13, wherein the air deflector cover comprises a curved portion.

16. The motor vehicle claim 15, wherein the curved portion curves inward towards the housing.

17. The motor vehicle of claim 12, wherein the air deflector cover is coupled to an outboard portion of the housing.

18. The motor vehicle of claim 17, wherein the air deflector cover forms a cup-shaped portion, wherein the one or more flaps may enter a space in the cup-shaped portion when in the open position.

19. The motor vehicle of claim 11, wherein the one or more flaps comprises a plurality of flaps.

20. The motor vehicle of claim 11, wherein the one or more flaps are configured to hang from one or more pivot supports coupled to the housing.
